(19) United States
(12) Patent Application Publication
(10) Pub. No.: US 2025/0316921 A1
(43) Pub. Date: Oct. 9, 2025

(54) PIN HEADER PLUG-AND-SOCKET CONNECTOR

(71) Applicant: Weidmüller Interface GmbH & Co. KG, Detmold (DE)

(72) Inventor: Marc REGER, Lage (DE)

(21) Appl. No.: 19/169,589

(22) Filed: Apr. 3, 2025

(30) Foreign Application Priority Data
Apr. 4, 2024 (DE) 102024109479.6

(51) Int. Cl. H01R 13/422

(52) U.S. Cl. CPC H01R 13/4223

(57) ABSTRACT

A pin header plug-and-socket connector including a plurality of plug-and-socket connector modules lined up in a strip-like manner in a lining-up direction each including a module housing and a contact element. The module housings each have a plugging face section and a mounting contour receptacle containing an opening for inserting and mounting the contact element in at least one spatial direction into the module housing. Each contact element has a plug contact and solder pin, wherein the plug contact extends in a plugging direction perpendicular to the lining-up direction. The plug contact is arranged in the plugging face section where it is contactable and the solder pin protrudes out of the module housing such that it is able to be soldered onto a printed circuit board. The plug contact furthermore has one or two lateral attachment bars to retain the plug contact securely in a stationary and latching manner in the module housing by at least one corresponding latch of the module housing or in a form-fitting manner by at least one corresponding form-fitting element of a respectively lined-up adjacent module housing.

### BACKGROUND

The preset invention relates to a pin header plug-and-socket connector and particularly a plug-and-socket connector composed in a module-like manner from a plurality of plug-and-socket connector modules.

The contact elements of such known pin header plug-and-socket connectors can include a wire bent into an L-shape or a sheet metal cut-out that has a square or rectangular cross-section. One of the ends of the contact elements serves as a plug contact and the other serves as a solder pin.

It is also known from the state of the art to press contact pins into housings, which are then retained there in a force-fit manner by barbs. However, after prolonged use, the edges of the barbs are no longer sharp-edged due to the wear of the tool and hold less well. An additional disadvantage is relatively imprecise positioning when being pressed in, due to lateral tilting of the solder pins.

It is also known from EP 871 255 A1 that the contact elements are first positioned in the housing during the manufacturing process of the pin header plug-and-socket connectors. A retaining part is then inserted and affixed. Various options are conceivable for this purpose, for example the retaining part can be latched, glued or welded to the housing. It can also be envisaged that the retaining part engages in the housing in a form-fitting manner and latches on there. The arrangement of the retaining part is dictated by the design requirements in each case, with the retaining part being able to be inserted from above, from below or from the side. It is less advantageous that a supplementary retaining part has to be manufactured and mounted to affix the contact pins. Furthermore, a module-like structure of the plug-and-socket connector is costly, as one supplementary retaining part would have to be provided for each module housing.

### SUMMARY OF THE DISCLOSURE

In accordance with this, a pin header plug-and-socket connector is provided which is composed in a module-like manner from a plurality of plug-and-socket connector modules which are lined up in a strip-like manner in a lining-up direction. Each module has a module housing and a contact element. The module housings have a plugging face section and a mounting contour receptacle which is open for inserting and mounting the contact element in at least one spatial direction. The contact elements each have a plug contact, extending in a plugging direction perpendicular to the lining-up direction, and a solder pin. The plug contact is arranged in the plugging face section where it is contactable and wherein the solder pin protrudes out of the module housing such that it is able to be soldered onto a printed circuit board. The plug contact also has one or two lateral attachment bars to securely retain the contact element in the housing in a stationary manner by at least one corresponding latching element of the respective module housing or in a form-fitting manner by at least one corresponding form-fitting element of a respectively lined-up adjacent module housing.

In this way, it is possible to dispense with a supplementary part for fixing the contact element on the side of the mounting contour receptacle that is still open. Instead, its role is simply assumed by either the latching fixing in the module housing or the form-fit element of the adjacent module housing, which seals the mounting contour receptacle or preferably engages in the respective module housing with the contact element and fixes it there. A particular advantage is that production can be easily automated.

Compared to pressing-in the contact pins as previously described, there is better positioning and the disadvantages that arise from wear of the tool after prolonged use are avoided from the outset.

The solder pin and the plug contact are preferably connected to each other at an angle, in particular at an angle of 90°. However, they can also be arranged aligned in a straight line.

The first alternative of the latching fixing can, for example, be advantageously implemented in that the respective plug contact is fixed in a latching and stationary manner in the mounting contour receptacle on one or both attachment bars.

Furthermore, it can be envisaged that the respective plug contact in the mounting contour receptacle is fixed on one of the two or on both attachment bars in each case in a latching manner with the aid of one or two resilient latching spring bars which are provided on the module housings. Each of these have a latching receptacle in which the respective attachment bar engages in a latching manner upon insertion into the mounting contour receptacle. According to this solution, the contact element is retained well in a secure and centered manner, in particular when the latching spring bars receive the attachment bars from opposite sides.

In another embodiment, after a type of kinematic reversal, it can be envisaged that only a single attachment bar is provided on the contact element. The attachment bar of the plug contact has at least one latching window into which one or more latching spring hooks that are configured in the mounting contour receptacle latchingly engage in a resilient and latching manner upon insertion into the mounting contour receptacle.

In an alternative embodiment, form-fitting can be further developed in that the corresponding form-fit element of a respectively lined-up adjacent module housing includes at least one housing engagement bar which engages in a receiving slot of the mounting contour receptacle. The housing engagement bar secures at least one of the attachment bars form-fittingly in a stationary manner.

For this purpose, it can be envisaged that the housing engagement bar secures the respective attachment bar of the contact element in a stationary manner from falling out parallel to the plugging direction of the plug-and-socket connector. However, it is also advantageously possible to realize a variant in which the housing engagement bar secures the attachment bar in a stationary manner from falling out parallel to the lining-up direction.

It can be particularly advantageous to have two attachment bars in each case provided on the contact element, wherein they are aligned at an approximate right angle to the plug contact of the contact element. They attach to the contact element and extend away from it in the opposite direction. This effectively guarantees that the respective contact element can be well secured in a stationary manner.

In another embodiment, two housing engagement bars are provided, which each extend in opposite directions on the module housings and which each engage in one of the receiving slots to secure one of the attachment bars in a form-fitting and stationary manner.

In a further embodiment, the housing engagement bars and/or the attachment bars taper in a wedge-shape in sections to simplify mounting the plug-and-socket connector modules onto one another.

It is conceivable for the module housing to be configured open in the lining-up direction and for the respectively lined-up module housing to be arranged on this open side of the module housings to close the housings and secure the contact element there in a form-fitting manner.

It can also be envisaged that the module housings of the plug-and-socket connector modules have corresponding form-fit mechanisms and/or latching mechanisms, such that they are able to be lined up and affixed together in the lining-up direction of the plug-and-socket connector modules.

### BRIEF DESCRIPTION OF THE DRAWINGS

Exemplary embodiments of the invention will be described below with the aid of the enclosed drawings. However, the invention is not limited to these exemplary embodiments and may be implemented in a different form. Individual features of the exemplary embodiments described below can also be combined with features of other exemplary embodiments in a different way than depicted below. In the drawings:

FIGS. 1a and 1b are perspective views of a first plug-and-socket connector module for a first pin header plug-and-socket connector;

FIG. 1c is perspective view of two plug-and-socket connector modules arranged alongside one another and not yet connected to form a pin header plug-and-socket connector;

FIG. 1d is a perspective view of three plug-and-socket connector modules and an end plate for a pin header plug-and-socket connector;

FIG. 1e is a perspective view of the pin header plug-and-socket connector of FIG. 1d as assembled;

FIG. 1f is a cross-sectional view of the pin header plug-and-socket connector of FIG. 1e;

FIGS. 2a and 2b are perspective views of a plug-and-socket connector module for a second pin header plug-and-socket connector;

FIGS. 2c and 2d are perspective views of two plug-and-socket connector modules that are arranged alongside one another and that are not yet connected to form a pin header plug-and-socket connector;

FIG. 2e is a perspective view of three plug-and-socket connector modules and an end plate for a pin header plug-and-socket connector wherein two of the plug-and-socket connector modules have been connected to one another;

FIG. 2f is the plug-and-socket connector modules and the end plate from FIG. 2e assembled to be a pin header plug-and-socket connector;

FIG. 2g is a cross-sectional view of the pin header plug-and-socket connector if FIG. 2f;

FIGS. 3a and 3b are perspective views of a plug-and-socket connector module for a third pin header plug-and-socket connector;

FIG. 3c is a perspective view of three plug-and-socket connector modules and an end plate arranged alongside one another and not yet connected to form a pin header plug-and-socket connector;

FIG. 3d is a cross-sectional view of the three plug-and-socket connector modules and an end plate of FIG. 3c, two of which have been connected to one another;

FIGS. 3e and 3f are perspective and cross-sectional views, respectively, of the plug-and-socket connector pin header of FIG. 3c in an assembled state;

FIG. 3g is a rear view of a section of two plug-and-socket connector modules upon assembly into the pin header plug-and-socket connector, with the housing of the central module having been omitted;

FIG. 3h is rear view of a detail A from FIG. 3g;

FIGS. 4a and 4b are perspective views of a plug-and-socket connector module for a fourth pin header plug-and-socket connector;

FIG. 4c is a perspective view of three plug-and-socket connector modules and an end plate arranged alongside one another and not yet connected for a pin header plug-and-socket connector;

FIG. 4d is perspective view of the plug-and-socket connector modules and the end plate from FIG. 4c assembled as a pin header;

FIG. 5a is perspective view of a plug-and-socket connector module for a fifth pin header plug-and-socket connector when being assembled;

FIG. 5b is a cross-sectional view of the connector of FIG. 5a;

FIG. 5c is a perspective view of the plug-and-socket connector module from FIG. 5a in the assembled state;

FIG. 5d is a cross-sectional view of the connector of FIG. 5c;

FIGS. 6a-6c are perspective views of a plug-and-socket connector module for a sixth pin header plug-and-socket connector shown with step-by-step assembly, respectively;

FIG. 6d is a cross-sectional view of the plug-and-socket connector module from FIG. 6c;

FIGS. 6e and 6f are perspective and cross-sectional views of the plug-and-socket connector module from FIG. 6c in an assembled state;

FIGS. 7a-7c are perspective views of a first plug-and-socket connector module for a seventh pin header plug-and-socket connector shown with step-by-step assembly, respectively;

FIG. 7d is a cross-sectional view of the arrangement of FIG. 7c;

FIGS. 7e and 7f are perspective and cross-sectional views of the plug-and-socket connector module of FIG. 7c;

FIGS. 7g and 7h are rear and perspective views of the plug-and-socket connector module from FIG. 7e;

FIG. 8a is a perspective view of a plug-and-socket connector module for an eighth pin header plug-and-socket connector not yet connected with the module housing of FIGS. 7a-7h; and

FIGS. 8b and 8c are a rear and perspective views of the plug-and-socket connector module from FIG. 8a in the assembled state.

### DETAILED DESCRIPTION

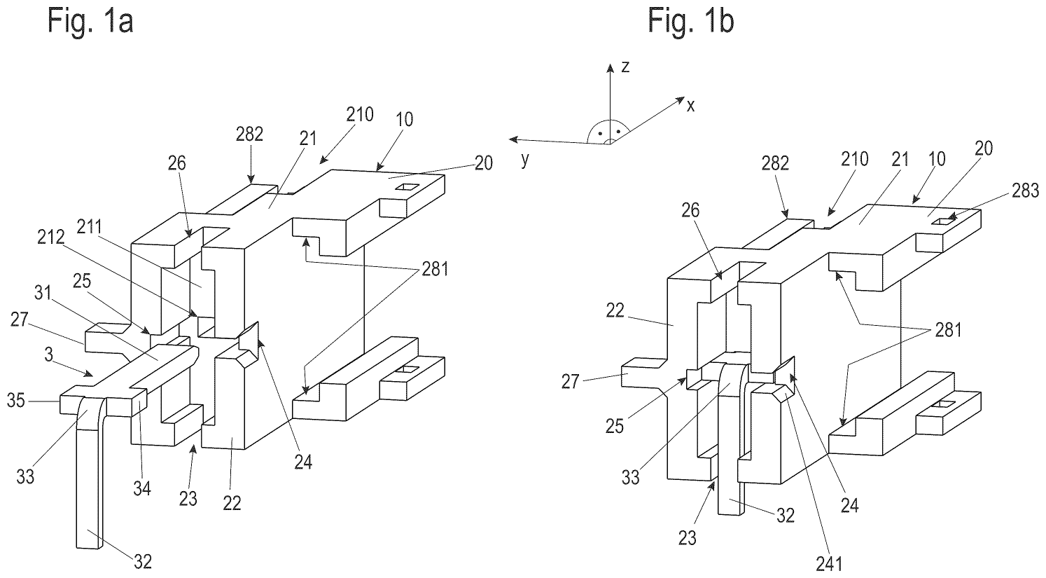

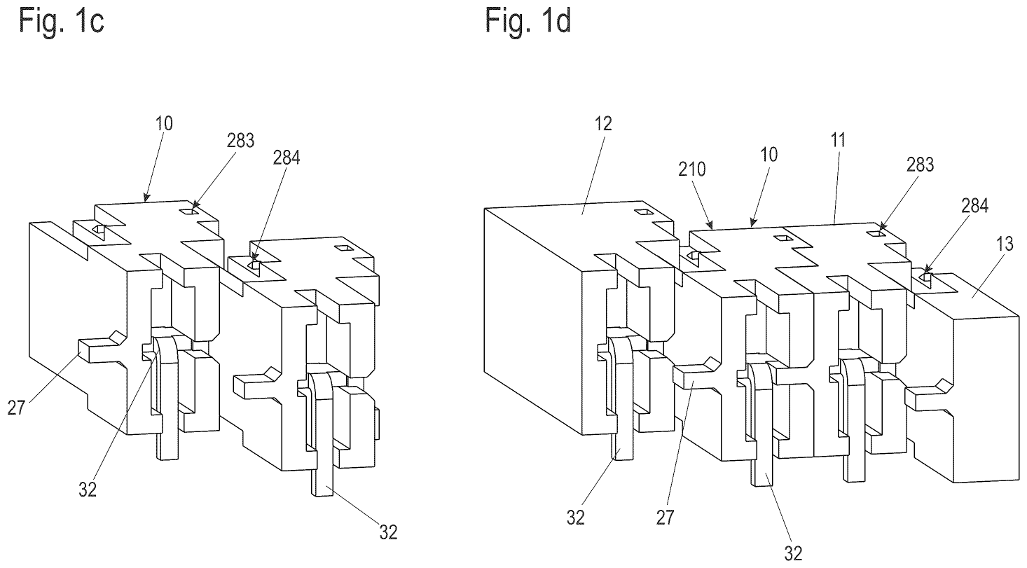

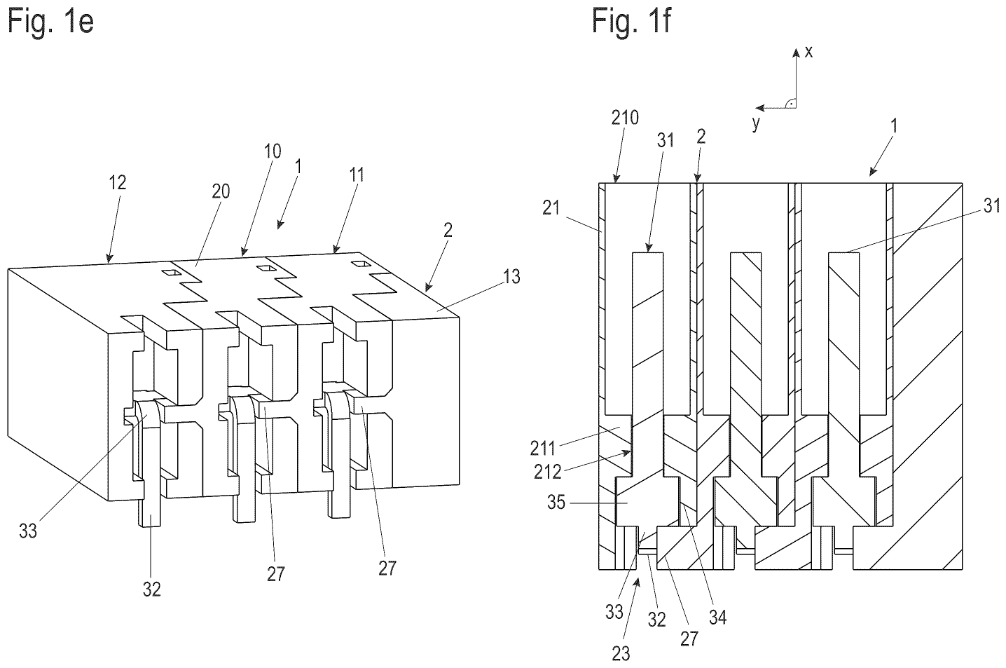

FIGS. 1a and 1b each depict a single plug-and-socket connector module 10 for a pin header plug-and-socket connector 1 (see FIGS. 1e and 1f). A number of the plug-and-socket connector modules 10 can be put together to form the pin header plug-and-socket connector 1.

The plug-and-socket connector module 10 has a housing 20 into which a contact element 3, which is bent out of a sheet metal blank, is placed. The pin header plug-and-socket connector 1 has at least two or more, preferably three or more, of the plug-and-socket connector modules 10, 11, 12 and preferably an end plate 13 as a partial housing. These can be connected to form the pin header plug-and-socket connector 1. The quantity of the plug-and-socket connector modules 10 of the pin header plug-and-socket connector may vary. In the assembled state, the individual module housings 20 form a superordinate plug-and-socket connector housing 2 (also referred to as a pin header housing).

The contact elements 3 are made of a metal which conducts electricity well, for example a copper alloy. The contact elements 3 are bent approximately into an L-shape from an elongated sheet metal blank. One of the two legs of the L is configured as a plug contact 31, which has a rectangular cross-sectional shape and thus forms a kind of contact blade. The plug contact 31 is used for plugging together with a corresponding mating plug contact (not shown here) which can be configured as a type of contact tulip.

The other leg of the substantially L-shaped contact element is configured as a solder pin 32, which can be inserted, in particular pressed, into a printed circuit board (not shown) and be soldered into place there. The solder pin 32 has a rectangular cross-section.

These cross-sections of the plug contact 31 and the solder pin 32 are advantageous but can also be selected differently. For example, the plug contact 31 could have a square or round cross-section.

The plug contact 31 is connected to the solder pin 32 via a bend 33, so that the two legs of the L form an approximate 90° angle. The solder pin 32 can be aligned perpendicular to the lining-up and plugging directions, Y and X, respectively.

The leg of the contact element 3 which forms the plug contact 31 furthermore has two lateral attachment bars 34, 35, which are formed approximately at right angles to the plug contact 31, wherein they are attached to it and extend away from it in opposite directions. The bend 33 is located in the approximate region of the attachment bars 34, 35.

The contact element 3 configured in this way is manufactured simply and inexpensively.

In the embodiments of all figures, the solder pin 32 and the plug contact 31 are preferably connected to each other at an angle, and in particular at a 90° angle. However, they can be aligned in a straight line or at a different angle. Regardless, the two attachment bars 34, 35 are arranged in a region between the plug contact 31 and the solder pin 32.

It is preferable for only one contact element 3 to be provided for each plug-and-socket connector module 10. However, it will be understood that several contact elements 3 can be provided for each plug-and-socket connector module 10 (not shown here).

The respective contact element 3 is easily mountable in the respective plug-and-socket connector module 10 with a secure hold and desired alignment of the contact element 3 in the module housing 20 of the plug-and-socket connector module 10.

The module housings 20 have an approximately rectangular structure and can be put together to form a superordinate, bar-shaped plug-and-socket connector housing 2.

The module housings 20 of FIGS. 1a-1f have a plug contact housing section 21, which surrounds the plug contact 31 like a collar (e.g. a partially or fully closed rectangular collar). This plug contact housing section 21 is configured to be open towards a plugging face side 210 (see also FIG. 1f) and substantially closed via a partition wall 211 on the side facing away from the plugging face 210—except for an opening 212 for pushing the plug contact 31 through the partition wall 211. The cross-section of the opening 212 substantially corresponds to the cross-section of the plug contact 31.

A mounting contour receptacle 22 adjoins the plug contact housing section 21 and is configured as an approximately rectangular collar, which adjoins the partition wall 211 on the side facing away from the plug-and-socket connector section 21. According to FIGS. 1a-1f, the mounting contour receptacle 22 is open at the end facing away from the partition wall 211 (see in particular also FIG. 1f).

The mounting contour receptacle 22 can have, on its side facing away from the plugging face 210, one or more receiving slots 23-26 for receiving a part of the contact element 3, in this case the solder pin 32 and the attachment bars 34, 35. These receiving slots 23 to 26 are arranged and aligned in such a way that the solder pin 32 can engage in one of the receiving slots 23 and the attachment bars 34 and 35 can engage in the lateral receiving slots 24 and 25 (FIG. 1b).

As shown in FIGS. 1a-1f, there are three receiving slots 23, 24, 25 to mount the contact element 3.

There is a fourth, optional receiving slot 26 that makes it possible for the contact element 3 to be installed in a position 180° rotated relative to FIGS. 1a and 1b, in which case it replaces the receiving slot 23 for receiving the solder pin 32.

The three or here four receiving and mounting slots 23, 24, 25, 26 are preferably configured at right angles to each other—approximately in a cross-shape according to FIGS. 1a-1e—in the walls of the collar-like mounting contour receptacle 22.

In this way, the contact element 3 can be inserted into the module housing 20 of the respective plug-and-socket connector module 10, 11, 12 from the rear (i.e. from the side facing away from the plugging face). Here, the mounting direction for mounting the contact element 3 is a direction parallel to the plugging direction X of the plug-and-socket connector.

The plug contact 31 is pushed through the opening 212 until the attachment bars 34 and 35 come to rest on the partition wall 211. The solder pin 32 is centered in sections in the receiving slot 23 and protrudes from it. In this way, the contact element 3 is already well secured and fixed in a form-fitting manner in several directions—except for one remaining direction (see FIG. 1b). However, to ensure the contact element 3 do not fall out of the module housing 20 in a direction counter to the plugging direction X, an additional fall-out prevention device is required.

According to FIGS. 1a-1f, there is a housing engagement bar 27 as an additional fall-out prevention device, which is provided on the mounting contour receptacle 22 and protrudes in the direction of a respectively adjacent module housing 20. It is designed to seal one of the receiving slots 24, 25 of a module housing 20 of a lined-up plug-and-socket connector module 12 (see FIGS. 1c, 1d, 1e, 1f) after the attachment bar 34 has been inserted. The respective attachment bar 34 of the contact element thus cannot fall out of the module housing 20 counter to the mounting direction X or, in this case, the plugging direction X.

For this purpose, the housing engagement bar 27 preferably engages in the receiving slot 24 in a region behind the attachment bar 34 in plugging direction X.

The receiving slot 24 has an introduction slope 241 to simplify mounting the housing engagement bar 27 of the adjacent module housing 20. In addition, the other receiving slot 25 can be configured closed on one side, with the housing engagement bar 27 being able to be molded onto the mounting contour receptacle 22 in this region.

Thus, two adjacent module housings 20 in the row of module housings in the plug-and-socket connector each have corresponding engagements—consisting of the housing engagement bar 27 and one of the receiving slots 24, 25, 26, one of which receives one of the attachment bars 34, 35 of the contact element 3 and the other of which secures this attachment bar 34 against falling out of the module housing 20 counter to the plugging direction X.

In order to line up the module housings 20 of neighboring plug-and-socket connector modules 10, 11, 12 together in a lining-up direction Y perpendicular to the plugging direction X to form a unified plug-and-socket connector, preferably the housings and possibly the end plate 13 have corresponding mounting and retaining contours. Here these include tongue/groove sliding-locking mechanisms 281, 282 and corresponding latching mechanisms 283, 284 (see in particular FIGS. 1a, 1b and 1c). At one end of such a plug-and-socket connector strip, which is composed of the plurality of plug-and-socket connector modules 12, 10, 11, it may be envisaged that the last of the plug-and-socket connector modules 12 in the row does not have a lateral housing engagement bar 27 and it may be envisaged that the end plate 13 is attached to the last plug-and-socket connector module 11 in the other direction. The end plate including the actual plate and the housing engagement bar 27, so that the contact element 3, in this direction Y in its module housing 20, is also retained and secured in this module housing 20 in all spatial directions X, Y and Z in a simple form-fit manner.

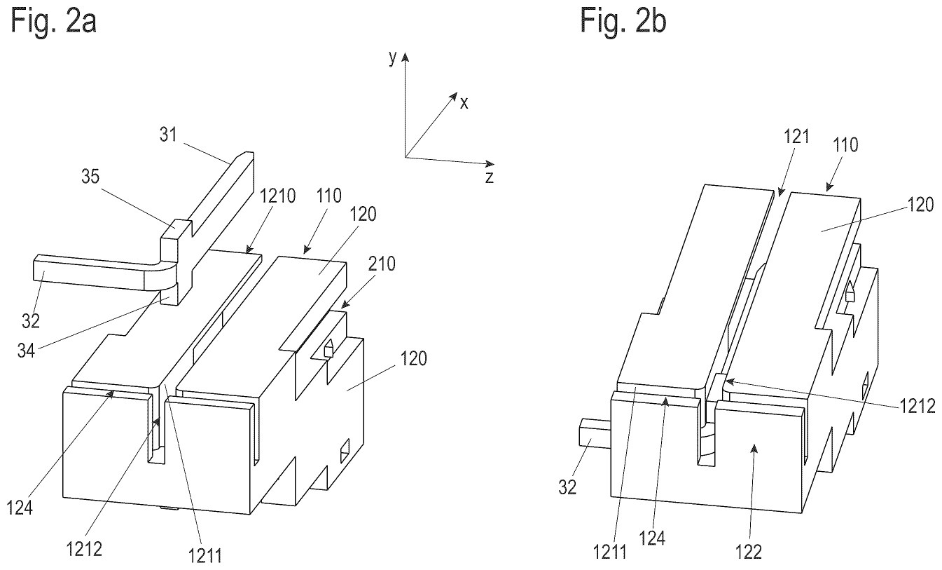

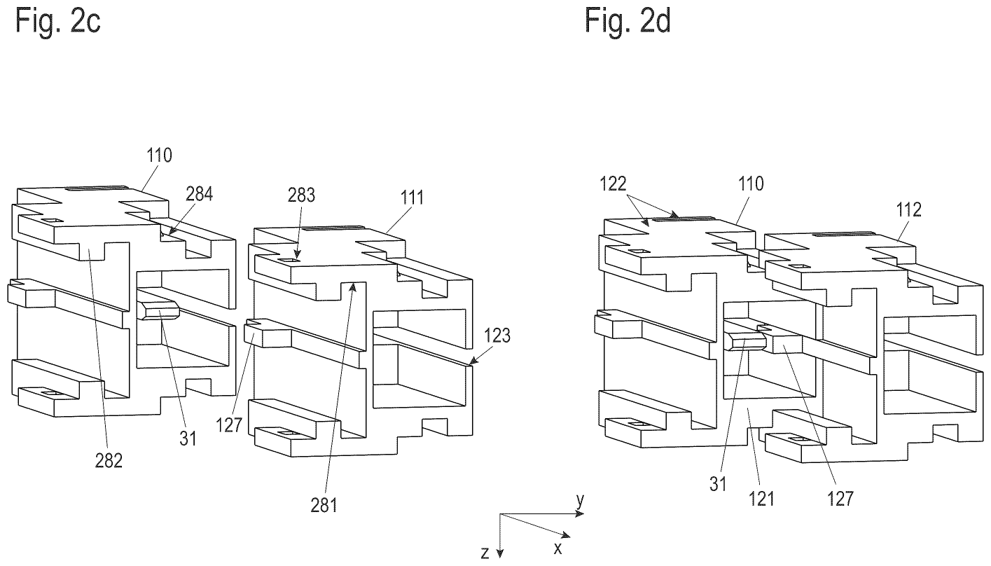

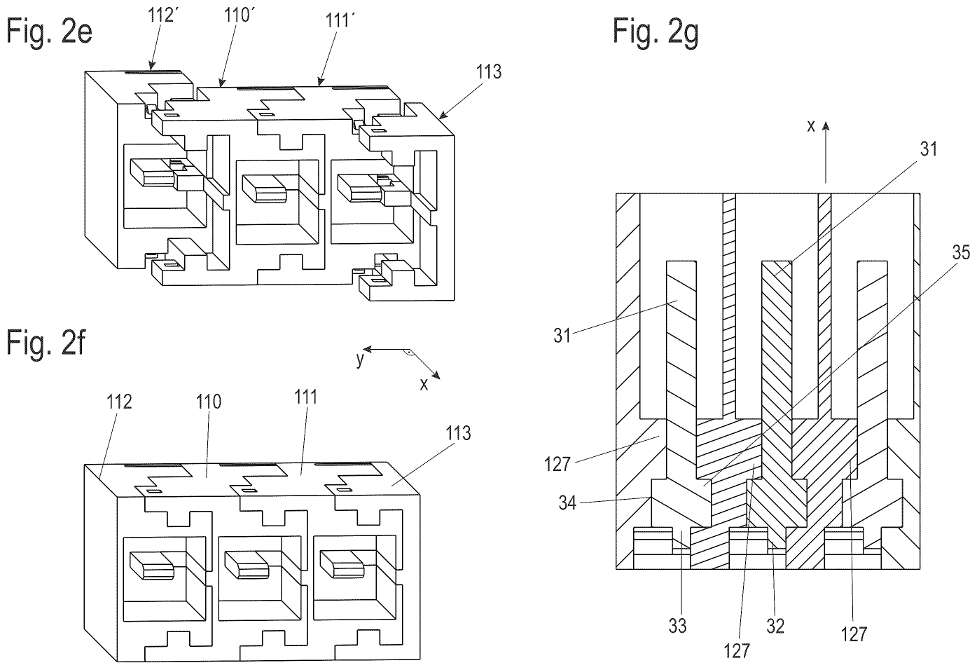

FIGS. 2a and 2b depict a plug-and-socket connector module 110 of a further embodiment of a pin header plug-and-socket connector 1 (see in particular also FIGS. 2e and 2f).

This plug-and-socket connector module 110 has a housing 120 into which the respective contact element 3—shaped here as in the embodiment of FIG. 1a—is to be placed. The pin header plug-and-socket connector 1 has at least two or more, preferably three or more of the plug-and-socket connector modules 110, 111, 112 and an end plate 113, which can be put together to form the pin header plug-and-socket connector 1. The quantity of the plug-and-socket connector modules 10 of the pin header plug-and-socket connector may vary. When put together, the individual module housings 120 in turn form a superordinate plug-and-socket connector housing 2.

It is preferable that only one of the contact elements 3 is provided for each plug-and-socket connector module 110. However, it will be understood that several contact elements 3 could be provided for each plug-and-socket connector module (not shown here).

The module housings 120 from FIG. 2f have a plug contact housing section 121, which surrounds the respective plug contact 31 approximately like a collar (like a partially or fully closed rectangular collar). This plug contact housing section 121 is configured to be open towards a plugging face side 1210 and is configured to be substantially closed on the side facing away from the plugging face 1210 by means of a partition wall 1211—except for a first opening slot 1212, which is preferably open to the side, for pushing the plug contact 31 in and through the partition wall 1211.

A mounting contour receptacle 122 adjoins the plug contact housing section 121. This mounting contour receptacle 122 is configured to be open in one direction—here in the Y direction, which is a direction parallel to the lining-up direction of the module housings 20—such that it is possible to push the plug contact 3 in from this side into the mounting contour receptacle 122, so that it is retained, in a form-fitting manner, in the other two spatial directions X and Z, respectively.

This is achieved in that the mounting contour receptacle 122 has one or more receptacles, in this case receiving slots 1212, 124, which are open in the Y-direction (FIG. 2a, 2b). In FIG. 2a, two of these slots 1212, 124 are provided, which are aligned perpendicular to each other here. In this way, the L-shaped contact element 3 can be inserted into these slots 123, 124 from the lining-up direction Y when it is correspondingly oriented or rotated in the space.

The module housings 20 then in turn have tongue/groove sliding-locking mechanisms 281, 282 and/or latching mechanisms 283, 284, so that they can be lined-up together in the Y direction and fixed in a stationary manner relative to one another.

A housing engagement bar 127 is provided on the module housings 120, which engages in one or both slots 1212, 124 such that this or these is/are sealed in the Y-direction and the plug contact 3 is secured in a form-fitting manner against falling out in this or in all spatial directions. The housing engagement bar 127 can, for example, engage in the slot 1212 such that it secures the contact element 3 to one of the attachment bars 34, 35 in a form-fitting manner.

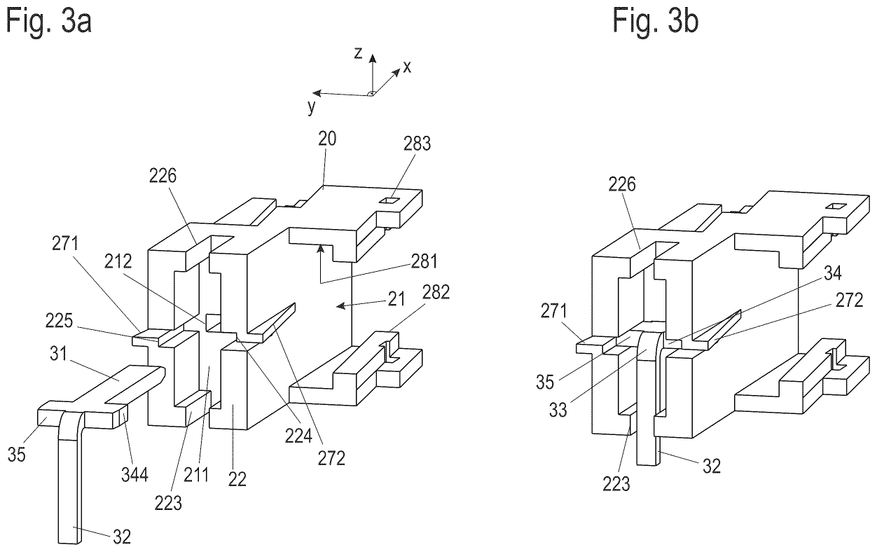

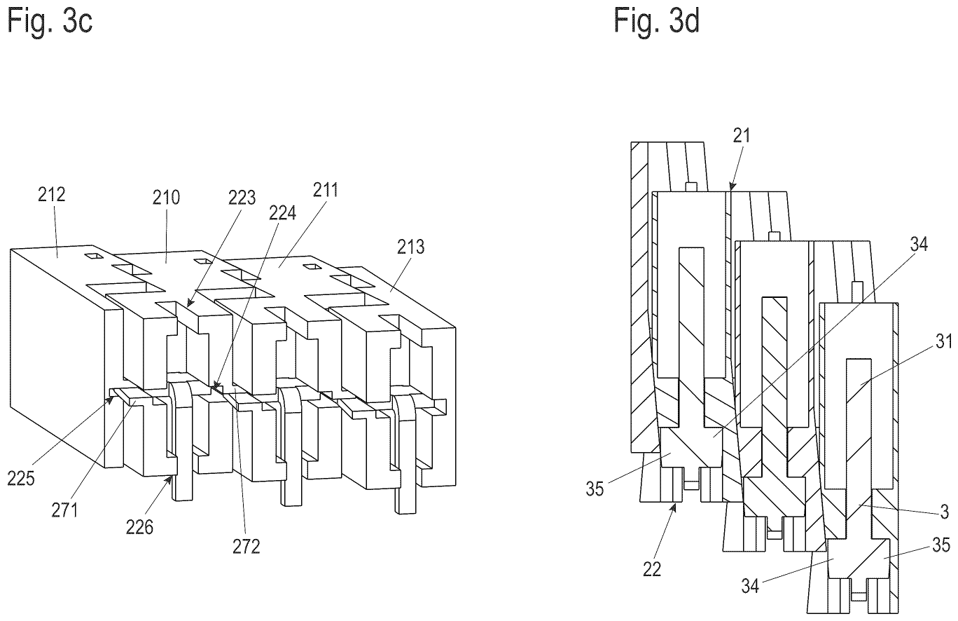

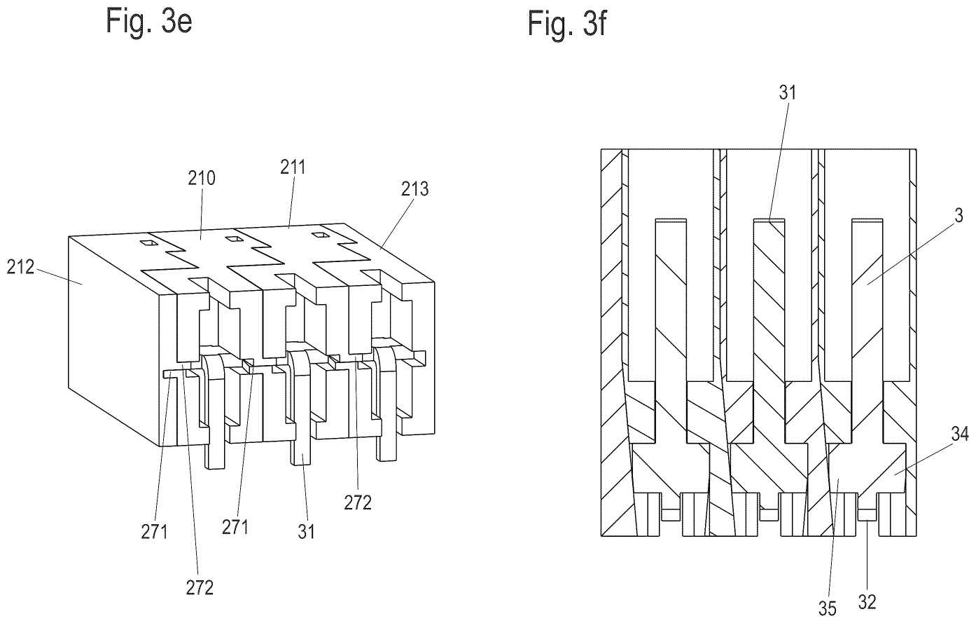

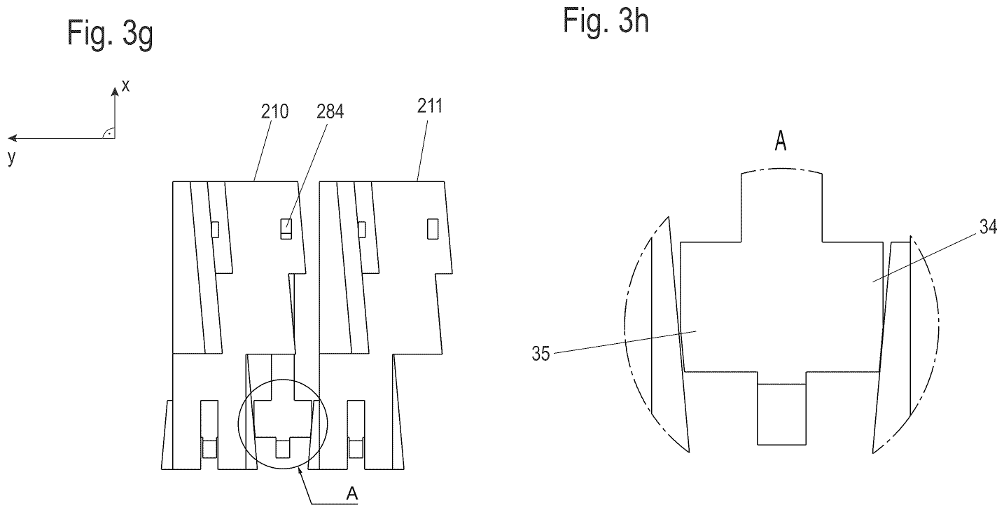

FIGS. 3a and 3b show a single plug-and-socket connector module 210 for a pin header plug-and-socket connector 1 (see FIGS. 3e and 3f). Several of the plug-and-socket connector modules 210, 211, 212 and possibly an end plate 213 (see in particular FIGS. 3a and 3d) can be put together to form the pin header plug-and-socket connector 1.

The basic structure of this plug-and-socket connector module 210 and the basic structure of the pin header plug-and-socket connector 1 from FIGS. 3a and 3b correspond to those in FIG. 2a.

In contrast to FIGS. 1a to 1f, however, the region in which the receiving slots 23, 24, 25, 26 and the housing engagement bar 27 are provided is formed differently in FIGS. 3a-h.

There are again three or four of the receiving slots 223, 224, 225, 226, which are also preferably aligned at right angles to one another. However, there is not only one of the housing engagement bars 271, 272 in one direction, but in two directions, i.e. in and against the lining-up direction, which thus extend in opposite directions away from the mounting contour receptacle. The housing engagement bars 271, 272 can taper in a wedge shape in the plugging direction X. The housing engagement bars 271, 272 are arranged offset to each other in the Z-direction perpendicular to the lining-up direction Y and to the plugging direction X in such a way that they can slide away over each other during assembly.

The housing engagement bars 271, 272 are further designed to engage in corresponding (Z-directional) offset sections or regions of the receiving slots 224, 225 extending substantially in the Y-direction.

First, as shown in FIGS. 3a-3b and 3c-3h, the plug contacts 3 are mounted in plugging direction X during assembly, as with FIGS. 1a-1e. Then, the module housings 20 of the plug-and-socket connector modules 212, 210, 211 and the end plate 213 are lined up together, being pushed together at an angle to each other in the X-direction and Y-direction (FIGS. 3c and 3e). When in the pushed-together state, the housing engagement bars 271, 272 secure the plug contacts in the module housings 220 in a direction counter to the plugging direction X. Particularly, both attachment bars 34, 35 are secure. The attachment bars 34, 35 can also taper conically in sections (see FIGS. 3g and 3h).

According to FIGS. 3a-3d, the module housings 220 have tongue/groove sliding-locking mechanisms 281, 282 and/or latching mechanisms 283, 284, so that they can be affixed to one another in the lining-up direction Y. These can taper in a wedge shape in the plugging direction.

In this manner, the individual plug-and-socket connector modules 210, 211, 212 can be lined up together and secured to one another particularly well.

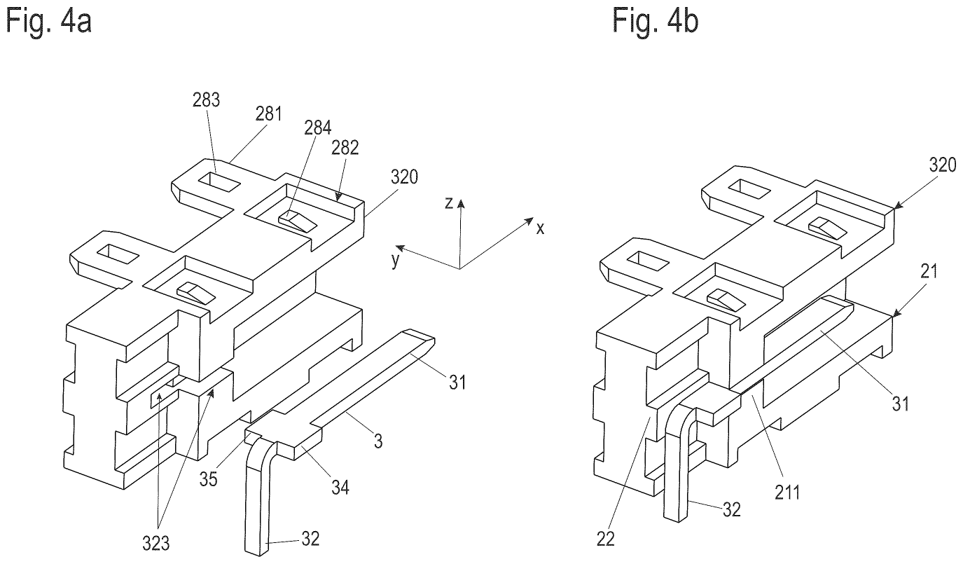

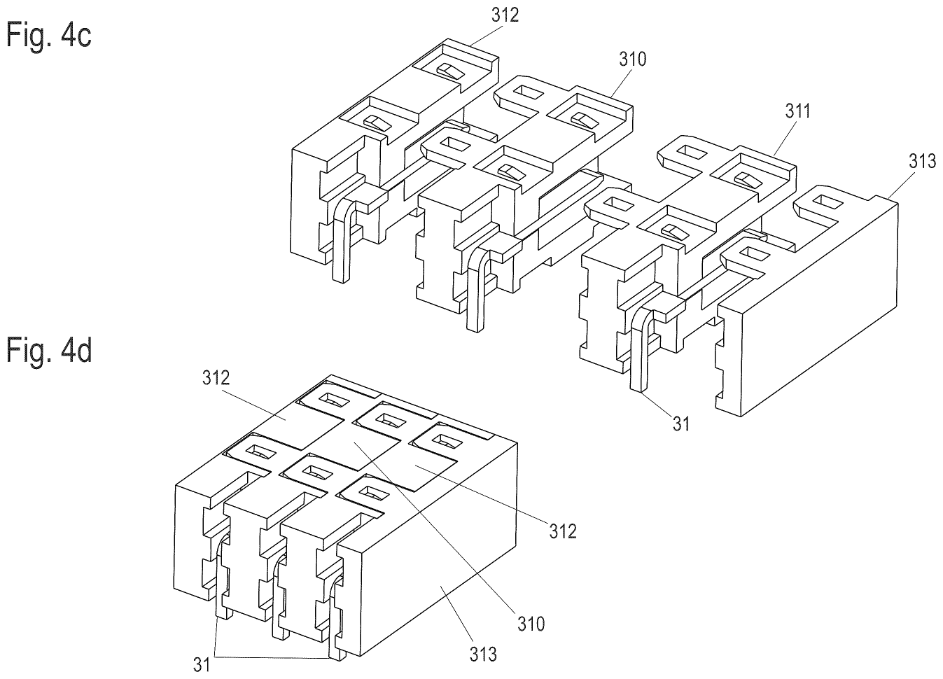

Referring to FIGS. 4a to 4d, the individual plug-and-socket connector modules 310, 311, 312 and the end plate 313 are lined up in the lining-up direction Y.

The individual module housings 320 are configured to be open in the lining-up direction Y as contact element receiving housings. Contact elements 3 can be inserted into them and held in a form-fitting manner in a mounting slot receptacle 323 that is open on one side in the lining-up direction. The contact elements are retained counter to the mounting direction when a lined-up module housing 310, 311, 312, or, if applicable, the end plate 313, has been mounted therewith. The next of the module housings of the plug-and-socket connector module 310, 311, 312 or the end plate 313 lined up next on the open side then seals, by its housing 20, the mounting slot receptacle 323 against the lining-up direction Y.

According to FIGS. 4a-4d, the module housings 320 can have sliding securing mechanisms 281, 282 and/or latching mechanisms 283, 284, so that they can be affixed to one another in the lining-up direction Y.

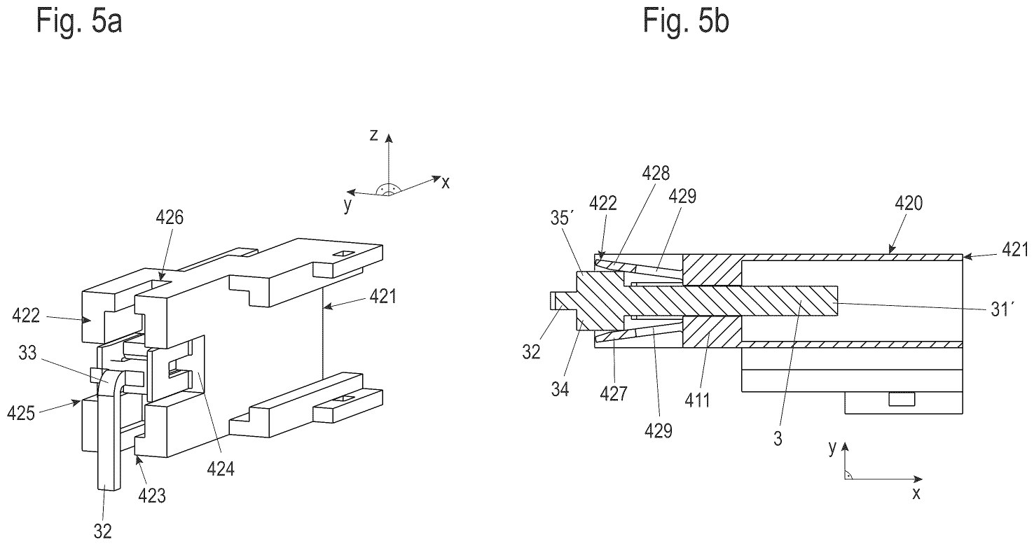

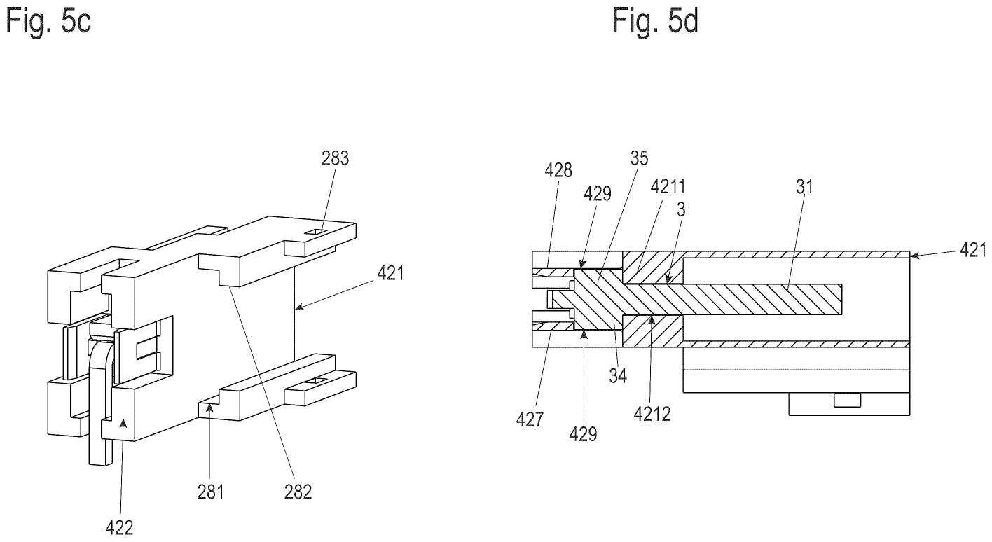

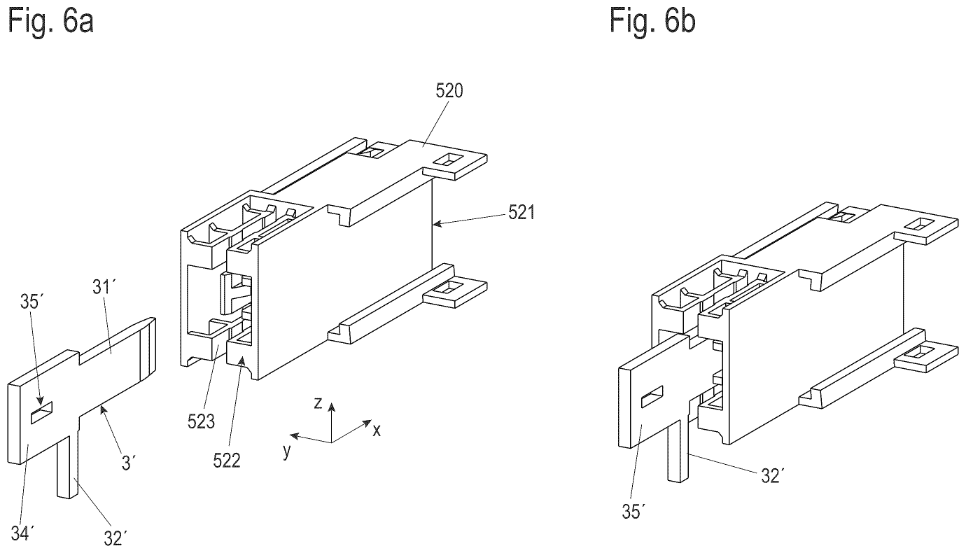

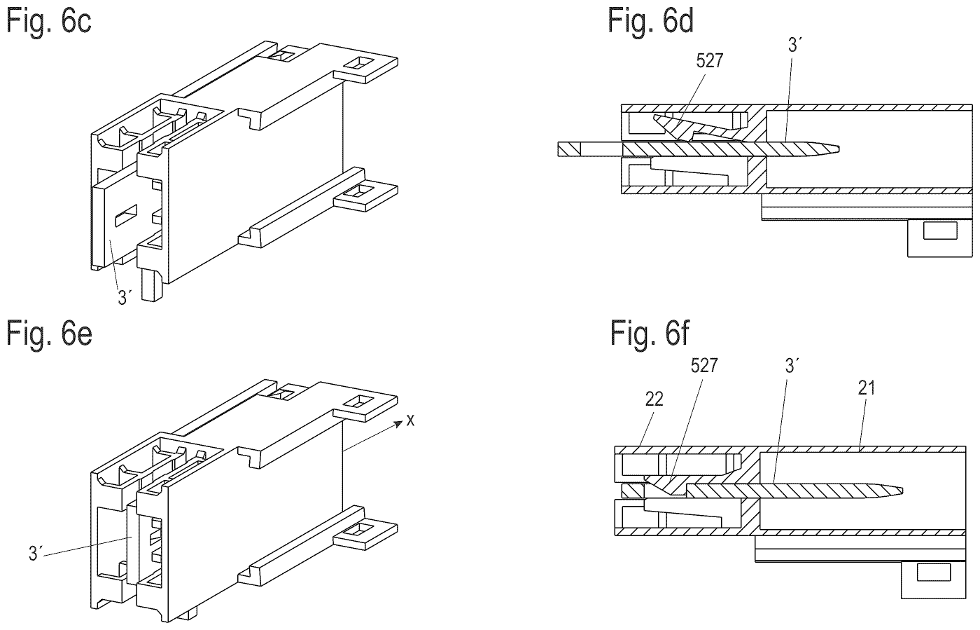

According to the embodiments of FIGS. 5a to 5d and 6a to 6d, the respective contact element 3 is inserted parallel to the plugging direction X through a mounting contour receptacle 422, into the respective module housing 420. The respective module housing 420 can be configured largely analogously to the module housings 20 of FIGS. 1a-1f. It can therefore in turn have a plug contact housing section 421, as well as a partition wall 4211 with an opening 4212 and a mounting contour receptacle 422 with mounting slots 423, 424, 425, 426, which act as a mounting contour receptacle.

To secure the respective contact element 3, which is first mounted in plugging direction X, as with FIGS. 1a and 1b, the contact element 3, 3′ is fixed in the respective module housing 420 in a latching manner on a single attachment bar 34′ (FIG. 6a-d) or on two attachment bars 34, 35 (FIG. 5a-d) and counter to the plugging direction X.

As shown in FIGS. 5a-5d, in the two mounting slots 424, 425 in which the lateral attachment bars 34, 35 of the contact element 4 engage, as with FIG. 1a, spring bars 427, 428 are provided on the housings 20, each of which has a latching receptacle 429. The spring bars 427, 428 extend counter to the plugging direction X and are configured in such a way that they spring back when the contact elements 3 are inserted and reached by the attachment bars 34, 35. When the contact elements 3 are pushed in further, the attachment bars 34, 35 then snap into the latching receptacles 429, so that the attachment bars 34, 35, and thus the entire contact element 3, is secured in the module housings 420 counter to the mounting direction. Adjacent module housings and the end plate (not shown) play no role in securing the contact elements in the module housings in this embodiment.

The module housings 420 can, in turn, have tongue/groove sliding-locking mechanisms 281, 282 and/or latching mechanisms 283, 284, so that they can be affixed to one another in the lining-up direction Y.

FIGS. 6a-6f show a kinematic reversal of this principle. Here, the respective contact element 3′ includes the solder pin 32′ and the plug contact 31′, but does not include two lateral attachment bars. Rather, it includes a single attachment bar 34′, which extends counter to plugging direction X and perpendicular to it, and which has at least one latching window 35′. At least one latching spring hook 527 of the module housing can latch and engage into the latching window when the contact element 3′ is pushed in. The at least one latching spring hook 527 can be provided and configured in the mounting slot 523. The module housing 520 of this embodiment can otherwise be configured largely analogous to that from FIGS. 1a-1b and 5a-5b.

As shown in FIGS. 6a-6d, the module housings 520 have tongue/groove sliding-locking mechanisms 281, 282 and/or latching mechanisms 283, 284, so that they can be affixed to one another in the lining-up direction Y.

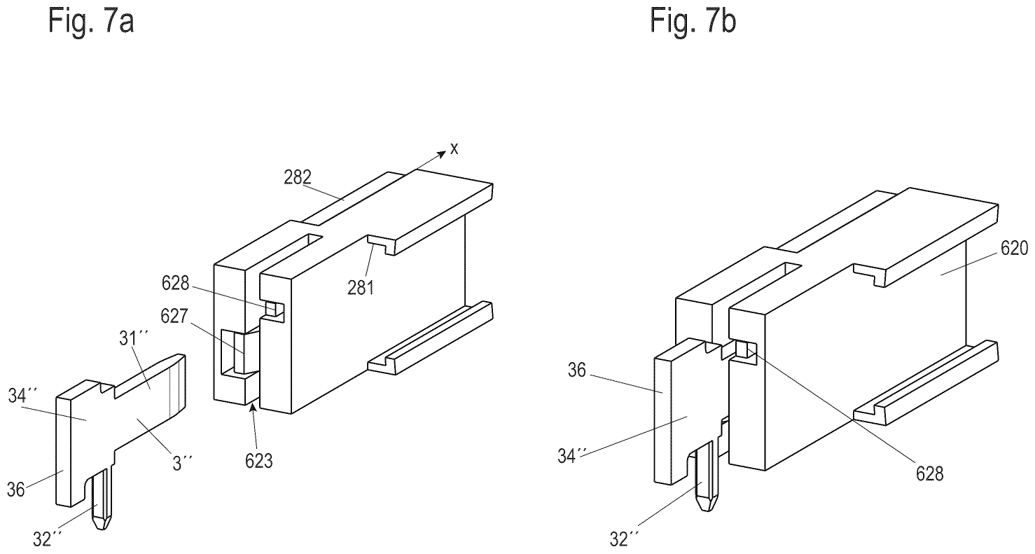

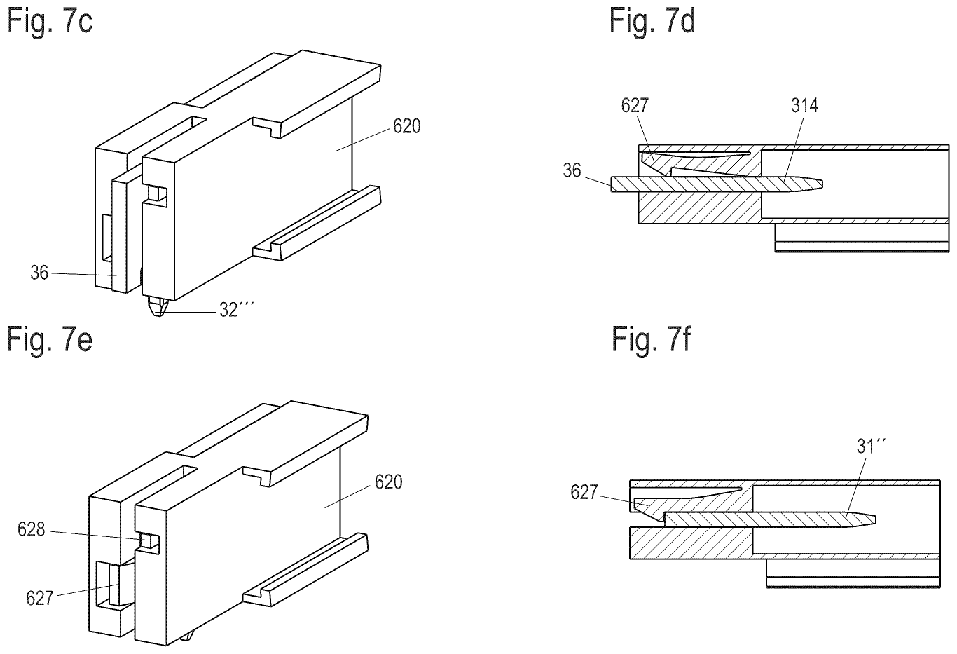

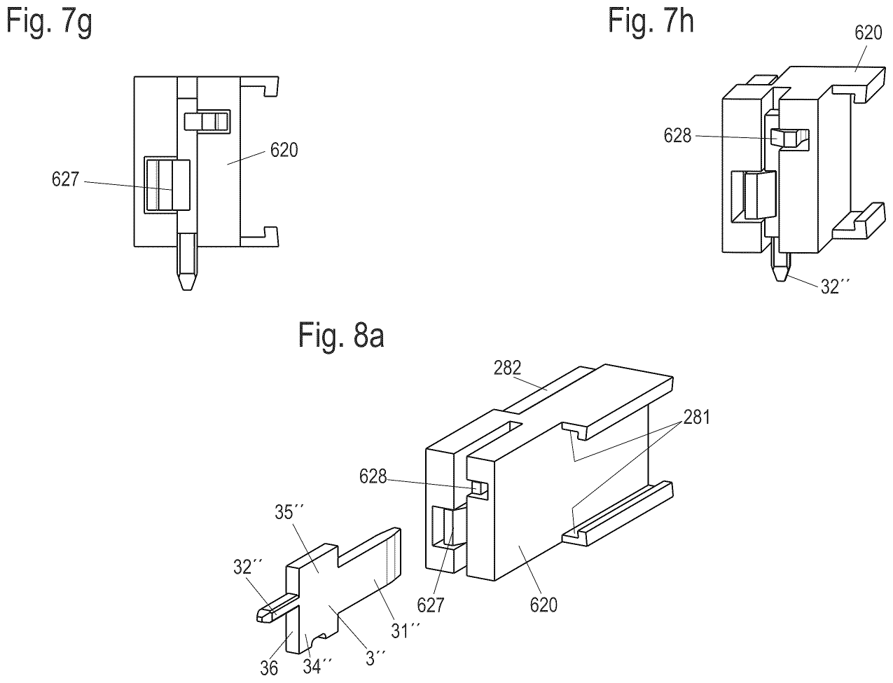

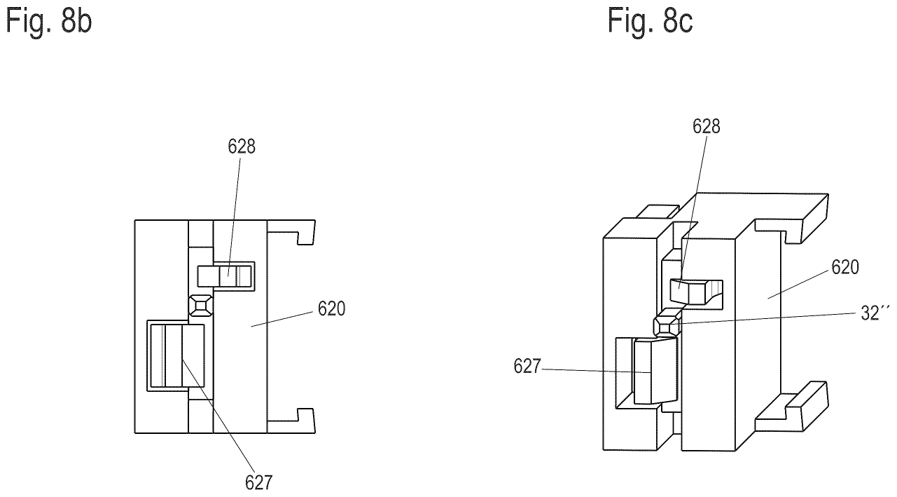

According to the embodiments of FIGS. 7a to 7h, the solder pin 32″ and the plug contact 31″ of the contact element 3″ are connected to each other at an angle, in particular at a 90° angle. In contrast, in the embodiment of FIGS. 8a-8c, the solder pin 32″ and the plug contact 31″ of the contact element 3″ are aligned in a straight line. Otherwise, the structure of the embodiments of FIGS. 7a-7h and 8a-8c are largely identical.

Referring again to FIGS. 7a-7h, the respective contact element 3″ does not have two lateral attachment bars, but rather in each case only a single lateral attachment bar 34″, which extends substantially in a surface counter to plugging direction X and perpendicular to plugging direction X. The lateral bar has at least one latching edge 36 at its end facing away from plugging direction X, behind which two latching spring hooks 627, 628 of the module housing can latch and engage when the contact element 3′ is pushed in.

According to FIGS. 8a-8h, the contact element 3″ has two lateral attachment bars 34″ and 35″ which extend substantially perpendicular to plugging direction X. It also has at least one latching edge 36 in the region of the attachment bars 34″, 35″ at the end facing away from plugging direction X, and behind which two latching spring hooks 627, 628 of the module housing can latch and engage when the contact element 3′ is pushed in.

The latching spring hook 627 can be provided and configured in the mounting slot 623. The module housing 620 of these embodiments can otherwise be configured largely analogously to those of FIGS. 1a-1b, 5a-5b, and 6a-6b.

The module housings 620 of the embodiments of FIGS. 7a-7h and 8a-8c has tongue/groove sliding-locking mechanisms 281, 282 and optionally or alternatively (not shown) latching mechanisms 283, 284, so that they can be affixed to one another in the lining-up direction Y.

The module housings 620 of the embodiments from FIGS. 7a-7h and 8a-8c can be configured identically, i.e. they can be used for both the 90° contact pins 3″ and for straight contact pins 3″.

What is claimed is:

1. A pin header plug-and-socket connector including a plurality of plug-and-socket connector modules arranged in a strip-like manner in a lining-up direction, each plug-and-socket connector module comprising a module housing and a contact element, the module housing having a plugging face section and a mounting contour receptacle containing an opening for inserting and mounting the contact element in at least one spatial direction into the module housing, the contact element having a plug contact extending in a plugging direction perpendicular to the lining-up direction and a solder pin, the plug contact being contactably arranged in the module housing plugging face section and the solder pin protruding out of the module housing for soldering onto a printed circuit board, wherein
the plug contact of the contact element has at least one lateral attachment bar; and
the contact element is retained in the module housing on the at least one lateral attachment bar via one of at least one corresponding latch of the module housing and at least one corresponding form-fitting element of an adjacent plug-and-socket connector module housing.

2. The pin header plug-and-socket connector according to claim 1, wherein each contact element has two attachment bars aligned at an angle to and attached to the plug contact of the contact element extending from the plug contact in opposite directions.

3. The pin header plug-and-socket connector according to claim 1, wherein the solder pin and the plug contact are one of perpendicularly and linearly connected.

4. The pin header plug-and-socket connector according to claim 1, wherein the at least one lateral attachment bar is arranged perpendicular to the plug contact of the contact element.

5. The pin header plug-and-socket connector according to claim 1, wherein the plug contact is latched in the mounting contour receptacle on the at least one attachment bar.

6. The pin header plug-and-socket connector according to claim 5, wherein the plug contact is latched via at least one resilient latching spring bar arranged on the module housing, the at least one resilient latching spring bard having a latching receptacle for latching engagement with the at least one attachment bar when the at least one attachment bar is inserted into the mounting contour receptacle.

7. The pin header plug-and-socket connector according to claim 1, wherein each contact member includes one lateral attachment bar having at least one latching window, at least one latching spring hook configured in the mounting contour engaging into the latching window in a resilient latching manner when inserted into the mounting contour receptacle.

8. The pin header plug-and-socket connector according to claim 1, wherein the contact element at least one attachment bar has at least one latching edge, at least one latching spring hook configured in the mounting contour receptacle engaging the latching edge in a resilient latching manner when inserted into the mounting contour receptacle.

9. The pin header plug-and-socket connector according to claim 1, wherein the adjacent module housing form-fitting element includes at least one housing engagement bar for engagement in at least one receiving slot of the mounting contour receptacle, the housing engagement bar stationarily securing the at least one attachment bar.

10. The pin header plug-and-socket connector according to claim 9, wherein the housing engagement bar stationarily secures the at least one attachment bar from falling out parallel to the plugging direction.

11. The pin header plug-and-socket connector according to claim 9, wherein the housing engagement bar secures the at least one attachment bar from falling out in the lining-up direction of the plug-and-socket connector modules.

12. The pin header plug-and-socket connector according to claim 1, wherein the adjacent module housing form-fitting element includes two housing engagement bars each extending in opposite directions on the module housings to engage in at least one receiving slot and secure the at least one attachment bar in a form-fitting stationary manner.

13. The pin header plug-and-socket connector according to claim 12, wherein at least one of the housing engagement bars and the at least one attachment bar taper in a wedge-shape.

14. The pin header plug-and-socket connector according to claim 1, wherein the module housing of a plug-and-socket connector module has an open side in the lining-up direction and an adjacent lined-up module housing is arranged on the open side to close the open side and secure the contact element in a form-fitting manner.

15. The pin header plug-and-socket connector according to claim 1, wherein each module housing further has a plug contact housing section having a collar to surround the plug contact, wherein the plug contact housing section is open toward a plugging face side and is substantially closed on the side facing away from the plugging face by a partition wall, there being an opening for pushing the plug contact through the partition wall, wherein the mounting contour receptacle adjoins the partition wall.

16. The pin header plug-and-socket connector according to claim 6, wherein the resilient latching spring bar is arranged in the mounting contour receptacle.

17. The pin header plug-and-socket connector according to claim 1, wherein each module housing has one of corresponding form-fit element, a latching element, and both a form-fit element and latching element to lined up and affix the housings in the lining-up direction of the plug-and-socket connector modules.
